(19) United States
(12) Patent Application Publication
(10) Pub. No.: US 2016/0042578 A1
(43) Pub. Date: Feb. 11, 2016

(54) ON BOARD DIAGNOSTIC (OBD II) SPLITTER CABLE

(71) Applicant: Lisle Corporation, Clarinda, IA (US)

(72) Inventor: Michael L. Whitehead, Clarinda, IA (US)

(21) Appl. No.: 14/819,739

(22) Filed: Aug. 6, 2015

Related U.S. Application Data
(60) Provisional application No. 62/035,060, filed on Aug. 8, 2014.

(51) Int. Cl. G07C 5/08

(52) U.S. Cl. CPC G07C 5/0858; G07C 5/0808

(57) ABSTRACT

An on board diagnostic connector splitter cable system includes a first male connector assembly compatible with an on board diagnostic connection socket mounted in a motor vehicle and further includes a second female socket assembly having corresponding pins linked by a conductive cable assembly to the pins of the male first connector assembly. In addition, the power source pin and a ground pin of the first male socket are independently connected to first and second independent leads which may serve as a power and ground source independently of the second connector assembly associated with linking cable assembly. In this manner, vehicle components may be tested and/or powered using the vehicle power source through the independent leads.

### CROSS REFERENCE TO RELATED APPLICATION

This is a utility application incorporating by reference and claiming priority to provisional application Ser. No. 62/035,060 filed Aug. 8, 2014 entitled “On Board Diagnostic (OBD II) Splitter Cable”.

### BACKGROUND OF THE INVENTION

In a principal aspect, the present invention relates to a diagnostic cable for use with a motor vehicle on board diagnostic (OBD) system and, in particular, a cable to provide, in combination with an OBD II system, circuitry for properly and safely coupling of various electrical and electronic vehicle testing equipment devices and an on board vehicle diagnostic (OBD II) testing system.

Since 1996 light trucks and other vehicles in the United States have been mandated to include various apparatus on board for monitoring engine and other performance characteristics of the vehicle. Beginning in 2004 diesel engine vehicles required such on board monitoring capability. Specifications with respect to such vehicle monitoring systems are the subject of an On Board Diagnostic II (OBD II) cable interface in the vehicle having a standard pin construction that enable service personnel and mechanics the ability to use testing equipment connected to and interfaced with an on board diagnostic system (OBD II) and test or monitor various aspects of motor vehicle operation.

A standard on board diagnostic system (referred to as OBD II) comprises vehicle monitors and sensors that sense and measure performance by detecting aspects of the operation of individual components or subsystems of the vehicle. There are two types of monitoring activity: (1) continuous monitoring wherein monitors run continuously so long as the vehicle ignition key is turned “on” and/or the engine is running. Typically, there are three continuous monitors that every OBD II system equipped vehicle includes: the comprehensive component monitor, the fuel monitor and the misfire monitor; (2) Non-Continuous monitoring wherein monitors measure certain specific conditions such as speed, acceleration/deceleration, fuel level, temperature conditions and other aspects. Non-continuous monitors involve sensors for testing protocols that may evaluate the following:

Misfire—This monitor detects any engine misfires. A misfire occurs when the air/fuel mixture in an engine cylinder does not ignite. This condition may cause damage to the vehicle engine and/or catalytic converter. In the case of a severe misfire condition, the OBD II system will cause a malfunction indicator lamp to flash indicating a serious threat of damage to the catalytic converter.

Fuel System—This monitor constantly checks the amount of fuel used by the engine. Through the use of an oxygen sensor, the OBD II system can determine if more or less fuel is needed and thereby initiate a fuel flow adjustment. Fuel adjustment is performed many times a second is set to maximize fuel economy and minimize harmful emissions.

Comprehensive Component—This monitor evaluates various switches and sensors involved with engine management. Voltage readings, resistance readings, and other conditions are sensed. The monitor records readings from the vehicle components and compares them with programmed values that reflect what the readings should be. If the sensed values markedly differ from standard values, then that component may be defective.

Catalyst—(Also known as catalytic converter)—This monitor detects readings from oxygen sensors located a catalytic converter to determine the efficiency of the catalyst.

Heated Catalyst—Some vehicles may have an electrically heated catalyst. This heater helps warm up a cold catalyst so that it can start working sooner which leads to reduction of harmful emissions. This monitor determines whether the catalyst heater is working.

Evaporative System—This sensor monitors the evaporative system to minimize release of fuel vapors.

Secondary Air System—Some vehicles are equipped with a secondary air system, or air injection system. The air injection system is designed to place extra oxygen into the exhaust stream to reduce exhaust pollution. This monitor evaluates the components, switches, and solenoids of the air injection system.

A/C (Air Conditioning) System—In some vehicles, a sensor detects air conditioning system leaks.

Heated O2 (Oxygen) Sensor—Some oxygen sensors include an electric heater to warm them to an efficient temperature. The monitor ensures that the heater circuit for the oxygen sensor is working.

EGR (Exhaust Gas Recirculation) System—Many vehicles are equipped with an EGR system. The emissions control system is designed to reduce nitric oxide tailpipe emissions by reducing the temperature inside the engine's combustion chamber. The monitor senses the components of the EGR system to ensure they are functioning properly.

In order for a monitor to perform its testing function, specific conditions must typically be met. These conditions are collectively called a “drive cycle” and can include starting the vehicle when it is cold, running the vehicle until it is at normal operating temperature, driving the vehicle at different speeds, and turning the vehicle “off”. Some monitors only need one complete drive cycle to perform a test. Some monitors may require more than one drive cycle.

If the drive cycle requirements are not met, then the monitors or sensors cannot run a test. If one or more of the monitors cannot run a test, then a service person cannot or may not determine whether there is a problem with the vehicle component or subsystem that is being tested. In addition, there may be a malfunction(s) that could prevent the monitors from running to completion even if the drive cycle procedures are followed. In such a circumstance, the cause must be identified and corrected in order for the test to be successfully completed.

Each supported monitor can be either “ready” or “not ready”. Ready indicates that the required drive cycle has been completed and the associated tests have been performed. Not Ready indicates that the required drive cycle has not been run to completion; therefore the appropriate monitor has not tested the associated system.

During an OBD II inspection process, as conducted by state inspection authorities, mechanics, or service personnel, an emissions inspection analyzer may determine whether the vehicle's OBD II system is capable of providing the status of all of its OBD II monitors. If there are too many monitors that indicate “not ready” the analyzer may reject the vehicle from testing. For most 1996 to 2000 model year vehicles, up to two monitors are allowed to be in a “not ready” condition. For most 2001 and newer model year vehicles, only one monitor is allowed to be in a “not ready” condition in order to proceed with a full test of all vehicle components. If more than the allowed number of monitors are “not ready” the vehicle may be rejected from mandated government testing, and thus may require further diagnosis and repair by a mechanic or service personnel before further governmental testing and approval.

If the vehicle is not ready to be tested, that is, if it has been rejected from testing due to more than the allowed number of monitors being “ready”, it may also need to be driven in order to meet the necessary drive cycle(s) for the monitors that are reported as “not ready”. Information regarding specific drive cycles and what conditions are needed to meet the requirements of certain monitors may be available from the vehicle manufacturer, repair shop, aftermarket publications or the internet.

Monitors will typically reset to “not ready” when electrical power to the OBD II system is removed such as when the battery is disconnected, goes dead or is replaced. The monitors can also be reset by a person using an OBD II scanner that can plug into the data link connector. Through the use of the OBD II scanner, a person can clear or remove any diagnostic trouble codes (DTC's), but by doing this, the vehicle's readiness monitors are automatically reset to “not ready”. Any problems that have not been repaired will cause the OBD II system to store the DTC's again after the monitors run.

As a result of the described system protocols of the OBD II system, service personal and mechanics may be challenged to isolate and test various individual vehicle systems or components using the OBD II sensors and monitors. However, an OBD II system provides access to the myriad monitors and sensors. An objection of the invention, therefore, is nonetheless to enhance the efficient access of mechanics and service personnel to the sensors and vehicle components associated with an OBD II system.

For service personnel to repair a vehicle, therefore, the OBD II system provides access through a socket and cable that is typically connected to a diagnostic component such as a Scan Tool, Break Out Box, Memory Saver or another diagnostic devices. However, the connection socket for an OBD II test socket in a motor vehicle is often difficult to access. Such sockets are typically in the passenger compartment and usually near or under the front panel of the passenger compartment. The standardized OBD II sockets typically comprise 16 pin openings designed to receive a standard male pin connector of an OBD II cable which is then connected to a diagnostic device or component. The standard pin connectors of the OBD II socket include two ground pins; namely, pins 4 and 5 and a power source pin, 16, which accommodate a 12 volt power supply system. Various vehicle manufacturers use the remaining pins to connect with certain vehicle components involving standards and government specifications and to provide access to diagnostic information not necessarily mandated but made available through the various connection pins associated with the OBD II socket cable connector and diagnostic component arrangement.

Diagnostic testing of a vehicle typically requires that the engine of the vehicle be keyed “on”. On occasion this leads to difficulty for mechanics, for example, inasmuch as it may be inappropriate to start the engine in order to test some of the equipment or components of a motor vehicle. Further, many vehicles have different circuitry with respect to the diagnostic test associated with the various pins other than the pin position configuration designations that are standardized. Thus manufacturers may develop unique test cable connectors to link diagnostic devices and the standard on board diagnostic (OBD II) socket that receives input from various sensors and feed data from the vehicle to a test device. There may well be upwards of 5 or more protocols assigned to various pin configurations that pass through an OBD II connector to the OBD II vehicle system depending upon vehicle brand and age.

Additionally, the need for power independent of the vehicle OBD II system may be desired especially by mechanics or service personnel, for example. That is, generally there is no cable device which will enable independent power to be provided to vehicle components which are themselves linked solely to a multi-socket connector that connects the vehicle component being tested by power provided through the OBD II socket to a diagnostic device such as a Scan Tool. Thus, the power to the sensors in the vehicle is sourced by the internal circuitry of the vehicle and/or OBD II circuitry.

It is therefore an object of the invention to provide an on board diagnostic (OBD II) splitter cable which relies not only on the power derived from the internal vehicle battery/OBD II circuitry directly but also provides a means for an independent battery connection to be provided to the OBD II system to determine whether certain vehicle components are operating in a proper manner and to enable utilization of the OBD system to evaluate vehicle components even though the vehicle may not be “on”.

Another object of the invention is to provide a splitter cable capable of connecting various OBD II systems of various vehicle brands to various diagnostic devices.

A further object of the invention is to provide a rugged, utilitarian, and inexpensive splitter cable.

These and other objects, advantages and features of the invention are set forth in greater detail hereinafter.

### SUMMARY OF THE INVENTION

An on board diagnostic connector splitter cable includes a first connector assembly (typically pins) compatible with an on board diagnostic system (OBD II) connection socket mounted in a motor vehicle and further includes a second connector pin/socket assembly (typically sockets) having linked by a conductive linking cable assembly to the pins of the male first connector assembly. The second connector is connectable to testing equipment or diagnostic data display equipment. The power source pin (typically pin 16) and a ground pin (typically pin 4) of the male socket are also independently connected to first and second independent leads which may serve as a power lead (typically red lead) and ground lead (typically block lead) independently of the second connector assembly of linking cable assembly. In this manner, vehicle components may be tested and/or powered using a power source (e.g. the vehicle battery) through the independent leads red and black leads; namely, for example, connected to the vehicle battery even in the circumstance when the vehicle is not “on” and “not ready”.

The use of first and second socket pin assemblies may be altered or augmented by replacement or incorporation of socket assemblies for one or both of said first and second connectors. Such accommodation enables connectivity of the appropriate socket design of an OBD type system to a diagnostic device socket construction. Supplemental pin or socket assemblies thus may be used to transform any of the socket assemblies of the splitter cable device to provide a female or male socket that serves to redirect conductive connections via the pins and/or sockets. For example, a kit of additional pin and/or socket supplemental connectors would provide a universal and transformable cable assembly that would accommodate unique designations of OBD system contacts.

Further, since the independent power and ground leads may be used in combination with the vehicle battery, they may be utilized to independently evaluate the battery. Also, the independent power lead (red lead) may be attached to a test light which is in contract with the power lead of a battery thereby enabling the ground lead (black lead) to contact various components to verify they are properly grounded.

### BRIEF DESCRIPTION OF THE DRAWING

In the detail description which follows reference will be made to the drawing comprised of the following Figures:

FIG. 1 is a plan view of the splitter construction of the invention;

FIG. 2 is an end view of the on board diagnostic male connector designed for insertion into the on board diagnostic socket of a vehicle;

FIG. 3 is an end view of the female connector of FIG. 1 designed for coupling with diagnostic and power input socket of vehicle diagnostic apparatus; and

FIG. 4 is a plan view of a supplemental transition connector characterized by pins or sockets and leads which interface with the male connector of FIG. 2, by way of example, and the on board diagnostic socket of a vehicle wherein the transition connector is designed to be capable of connection to the unique socket configuration of an on board diagnostic connector.

### DETAILED DESCRIPTION OF AN EMBODIMENT OF THE INVENTION

The on board diagnostic—(OBD II) splitter or cable of the invention is comprised of a first male connector 10 which includes an open end plug assembly 12 comprising 16 pins numbered consecutively 1-16 as depicted, by way of example, in FIG. 2 an end view of the pin configuration 14 of male plug assembly 12. The first connector 10 includes a first electrical lead multi wire or cable 17 which provides unique and individual pin connections to the sockets 20 of a female second connector 18. The female socket connector 18 has corresponding, sequential sockets 1-16 as illustrated in FIG. 3 as the array of sockets 20. Thus, there is a one to one correspondence between the pins 14 of FIG. 2 and the sockets 20 of FIG. 3 and the conductively of and physical linkage of those pins 14 and sockets 20 through the cable or conduit 17 on a corresponding basis.

The splitter assembly further includes a second conductive wire or cable or lead 22 which includes two separate leads or cables, 25 and 26. The cable or lead 25 (black lead) connects pin 4 of the first connector 10 with a first female banana socket connector 24. Thus the lead 25 from pin 4 of first connector 10 to the banana socket 24 provides an independent vehicle ground link between the socket 24 and the pin 4. The pin 4 in accord with OBD II specifications is a ground.

In similar fashion the conductive wire or cable or lead 26 connects pin 16 of the first connector 10 with the second female banana socket connector 28. Thus the lead 26 from the pin 16 of first connector 10 to the banana socket 28 provides an independent power supply (red lead) between the socket 28 and the pin 16. The pin 16 in accord with OBD II specifications is a power supply.

Thus, independent of the female socket or second connector 18, the banana sockets 24 and 28 may be utilized to independently power various component parts of a vehicle. For example, the female socket 24 may serve as a ground for the windshield wiper of a motor vehicle whereas the second banana socket 28 may serve as a power source for the motor to verify that the motor is operating appropriately. Multiple other components of a vehicle which require power to one extent or another may thus be independently tested.

Further, if the vehicle battery connections are not providing proper power or amperage to component elements of a vehicle, the elements themselves may be individually tested to determine whether they are, in fact, a source of power loss or leakage or a short circuit. Additionally, the banana sockets 24 and 28 may be connected to an independent battery or power source and utilized to provide independent power source through the OBD II vehicle socket when the motor vehicle is not running or, in other words, when the key system is in the “off” position. Thus, the component parts of the vehicle may be tested without operation of the vehicle engine.

Typically, there are two pins in an OBD II standard male connector which are required as ground. Thus, for example, the pin 5 (which is typically ground for the vehicle computer “cpu”) could be substituted for pin 4 to provide a ground for lead 22. The use of pin 4 or pin 5 as equivalent structures is appropriate in order to accomplish the goals, aspects, objectives and benefits of the invention.

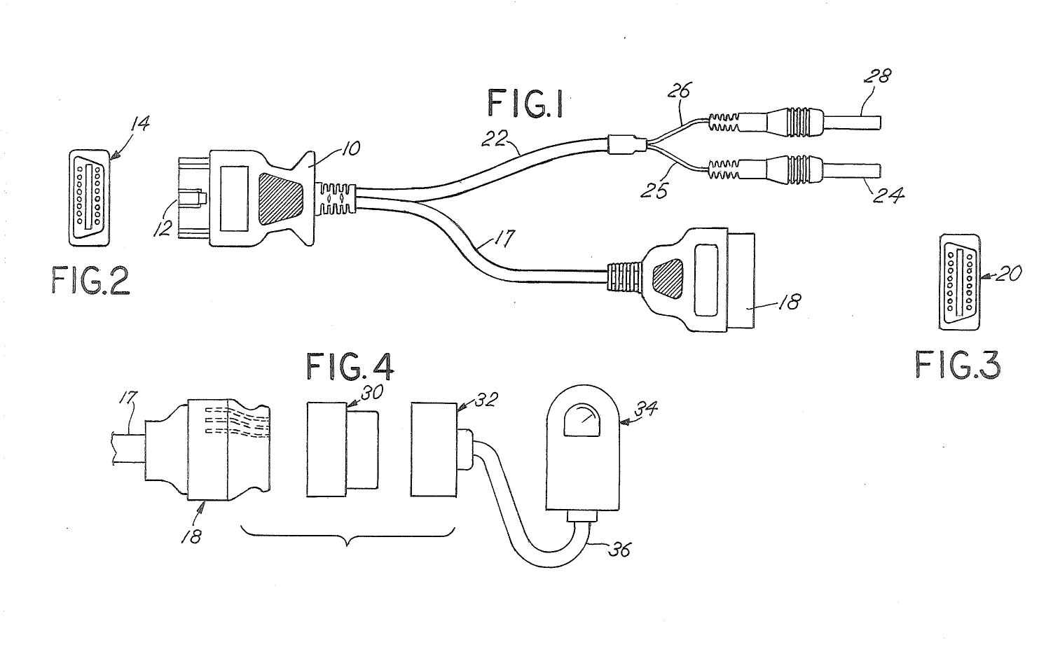

Further, a splitter cable construction of FIG. 1 is capable of combination with various types of diagnostic tools such as a volt meter, ammeter or the like. Also, a connector, such as second connector 18, may be connected to further socket(s) designed to provide diagnostic information in accord with the input originating with the OBD II. That is, a socket 20 may be connected to a transition socket 30 as depicted in FIG. 4 which includes an appropriate shape and pin or socket arrangement to connect to a sensor assembly 34 (e.g. data recorder) via socket 32 and cable 36 to record data for a computer programmed to analyze the data or information sensed. In this manner, the splitter cable of FIGS. 1-3 can be utilized to secure data through the OBD II socket without turning the engine to the “on” condition yet still utilizing the power from a battery or an external source which is provided through the leads 24 and 28. As a consequence, the cable assembly as disclosed may thus provide a universal conduit for technical information that can be quickly analyzed and recorded by a mechanic or service personnel.

Thus, the combination of the described splitter cable assembly enables manufacturers, including vehicle manufacturers, to provide software programs as well as customized supplemental connectors attachable to the splitter cable which may be utilized in combination with diagnostic tools such as volt meters, ammeters and other devices of that nature commonly found in vehicle repair facilities. Further, it is to be understood that the concept and aspects of the invention are dependent upon and guided by the design of the OBD II. That is, if the OBD II is changed, for example, by virtue of regulation or legislation or pursuant to vehicle manufacturer specification, a splitter assembly of the type described can be provided which incorporates the features of the present invention by means of equivalent combinations of sockets and leads with appropriate pin designations and placements.

As a consequence, the described splitter cable is limited only by the following claims and equivalents thereof. For example, the specific leads; namely, the banana sockets 24 and 28 may be substituted with another form or version of connector in order to accomplish the objectives of the invention. The leads as disclosed are preferred since they may be easily combined with other types of connectors such as alligator connectors or pins.

What is claimed is:

1. An on board diagnostic (OBD II) splitter cable assembly comprising:
a first sixteen pin male connector compatible with an OBDII socket, said first connector having numbered pins, 1-16 inclusive, including at least two generic pins number 4 and number 16, said number 4 pin comprising a ground connection and said number 16 pin comprising a power source connection, said remaining pins comprising designated contacts of vehicle manufacturers and standards authorities;
a second sixteen pin female connector having 16 numbered pins, 1-16 inclusive, compatible with a diagnostic test apparatus, said second connector numbered pin correspondingly conductively linked to the numbered pins of said first male connector whereby the pins of said first connector are capable of conductive engagement with an OBD II socket and said pins of said second connector are capable of conductive engagement to a said diagnostic test apparatus; and
said assembly further including s separate first lead from said first connector pin 4 to a first socket and including a second lead from said first connector pin 16 to a second lead whereby said first lead is capable of conductive connection respectively to ground and said second lead is capable of conductive connection to a power source, enabling independent power to a vehicle component when the vehicle electric system is not actuated by a vehicle key system.

2. The cable assembly of claim 1 wherein said first connector is positioned in conductive combination with an OBD II vehicle socket.

3. The cable assembly of claim 2 wherein said first lead is positioned in conductive combination with ground.

4. The cable assembly of claim 3 wherein said second lead is positioned in conductive combination with a power source.

5. The cable assembly of claim 4 wherein at least one of said first and second leads is a female banana head socket.

6. The cable system of claim 4 wherein said first and second leads are a female banana head socket.

7. The cable system of claim 1 wherein said second connector is positioned in conductive connection with a said diagnostic device.

8. The cable system of claim 7 wherein said second connector is positioned in conductive connection with a said diagnostic test device.

9. The cable system of claim 8 wherein one of said first leads is conductively connected to ground.

10. The cable system of claim 8 wherein said second lead is conductively connected to a power source.

11. The cable system of claim 10 wherein said power source comprises a battery of the vehicle connected through the OBD II socket.

12. The cable system of claim 1 comprising an alternate combination of pins and sockets of said first and second connectors.
